(19) United States
(12) Patent Application Publication
(10) Pub. No.: US 2026/0340621 A1
(43) Pub. Date: Oct. 29, 2026

(54) UNIFIED REQUESTS FOR DATA PROCESSING BETWEEN MULTIPLE DATA PROCESSING QUEUES

(71) Applicant: PAYPAL, INC., San Jose, CA (US)

(72) Inventors: Andrew Forsyth, London (GB); Jason Peter Broekhuizen, Edinburgh (GB); Mina Magdy Gamil Makary Mina, Solna (SE)

(21) Appl. No.: 19/187,735

(22) Filed: Apr. 23, 2025

(51) Int. Cl. G06Q 20/32; G06Q 20/40

(52) U.S. Cl. CPC G06Q 20/3278; G06Q 20/322; G06Q 20/407

(57) ABSTRACT

There are provided systems and methods for unified requests for data processing between multiple data processing queues. A user may engage in a transaction with a merchant to purchase goods, services, or other items at a physical merchant location. The merchant may provide payment processing through short-range wireless communications, such as RFID or NFC when the user's mobile device is tapped to a transceiver of the merchant's device. To process transactions generated on the user's mobile device through this mechanism, a transaction processor may generate a purchase record and identifier. The purchase identifier may be transmittable via short-range communications and may be transmitted with an identifier for a payment instrument. The merchant device may receive these two identifiers and proceed to process for a payment. The two identifiers may be processed by separate processors and allow for data correlation during storage for recordation.

### TECHNICAL FIELD

The present application generally relates to unifying data processing requests between different sub-systems and processing queues in an enterprise data system, and, more particularly, to integrating different data processing pipelines by recording identifiers created during or as a result of data processing by different sub-systems and components.

### BACKGROUND

Users may utilize online transaction processors for processing payments between different entities through device applications and digital accounts. Further, these online transaction processors may also provide payment options for in-person transaction processing and use at merchant locations. In this regard, merchants may utilize payment terminals for in-person payments with other merchant devices and/or system components, such as point-of-sale (POS) devices. These payment terminals and other components of the merchant device and/or system may be utilized for wireless data exchange and transaction processing. Merchants may implement payment services and processing functionalities from transaction processors through POS devices, payment terminals, and the like, which may accept payment via payment instruments and/or funds, such as cash, credit or debit cards, mobile applications and digital wallets, and the like. Conventionally, online transaction processors may have a main processor or other processing component for handling incoming transactions.

However, as payments and transaction processors become more global, and different components, teams, and/or domains are needed to provide different types of payment processing (e.g., credit, invoicing, billing, financial accounts, etc.), multiple different processors, processing components or stacks, queues, and the like may be used, which may not be compatible or may have issues with proper data format and handling. For example, invoicing may be part of a tap-to-pay (TTP) type processing where the user may “tap” or bring their device close to the merchant's device or payment terminal to effectuate a data transfer. This may lead to transaction processors having mismatching systems and/or components or only offering certain products and/or services in one domain or vertical, but not in another. Where integration may be desirable, some transaction processors or other service providers may do so inefficiently or with errors that cause data to be lost, tracked incorrectly, or handled inappropriately, which leads to customer dissatisfaction and distrust, as well as requiring the service provider to spend additional resources addressing such issues. Thus, it is desirable for online transaction processors to enable and provide compatibility and unification of data processing requests across multiple different systems, processing components, and queues so that data processing requests are properly tracked and routed for handling.

### BRIEF DESCRIPTION OF THE DRAWINGS

FIG. 1 is a block diagram of a networked system suitable for implementing the processes described herein, according to an embodiment;

FIGS. 2A-2C are exemplary diagrams of system components and processing flows that may be used when providing a tap-to-pay service for merchant invoicing that requires unification between multiple data processing queues, according to an embodiment;

FIGS. 3A and 3B are exemplary user interfaces of a mobile application on a mobile device usable when performing tap-to-pay processing of merchant invoicing, wherein data processing requests are tracked between different processing queues by correlating IDs, according to an embodiment;

FIG. 4 is a flowchart of an exemplary process for unified requests for data processing between multiple data processing queues, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for unified requests for data processing between multiple data processing queues. Systems suitable for practicing methods of the present disclosure are also provided.

A user may utilize a digital account, payment card, and/or other funding source to process payments through an electronic payment and/or transaction network associated with a backend payment processor or other entity on the network. An identifier (ID) may be linked to a digital account of the user with an online transaction processor, such as a payment service provider (e.g., PAYPAL®) which may provide electronic transaction processing services to users through the account and one or more, real-world physical locations, websites, and/or applications of the online transaction processor or a merchant. The online transaction processor may include an integration with the electronic payment network (e.g., for payment cards, tokens, and the like) that allows for data exchange and communications between the two networks, such as to process transactions (e.g., approve or decline, and well as request monetary payments, transfers, conversions, etc.) and issue receipts or other transaction histories. Further, this payment network may provide data communications and backend processing devices that provide for interaction with frontend merchant, POS, and/or payment terminal processing devices that process transactions.

Such frontend merchant devices may include point-of-sale (POS) devices and/or payment terminals processing payments using cash, check, and/or payment cards through near field communications (NFC), radio frequency identification (RFID) fields and communications, Bluetooth or WiFi communications, infrared scanners and/or communications, EMV chip readers, magnetic stripes and/or emulation readers, and other in-person and/or local data transfers. However, to utilize such payment mechanisms, specific data processors, data processing stacks, messaging queues, and formats for data communications and processing may be required. Conventionally, during transaction processing, “tap-to-pay” (TTP) processes may correspond to processes where short-range wireless communications may be used to exchange a digital token with a card reader, NFC or RFID chip or transceiver reader, or other payment terminal, such as a wallet token for a digital wallet or a token representing another payment instrument. This may be sent to a transaction processor, which may utilize a corresponding processor, such as a payment processing component of the transaction processor's computer system and architecture, which may utilize a reader/payment terminal application programming interface (API) and processing stack to process payment requests and digital tokens.

However, these processing components may be incompatible with current and/or new payment mechanisms and/or techniques, as well as application and/or website processes that may provide such payment mechanisms in a native software application or on a website of the online transaction processor. For example, consumer-side transaction generation, where a customer may create a transaction, invoice for processing a payment to, or other transaction data structure, document, and/or information for a payment to a small/micro business, solo merchant, or the like, may be performed in a mobile application. This process may not have a corresponding processing stack with a transaction processor that enables TTP processing or other short-range wireless communications, data exchanges, and protocols to exchange an invoice as the payment instrument and/or mechanism to a merchant device, such as a POS device and/or connected payment terminal. As such, both merchants and customers may be inconvenienced by the lack of compatible processing systems, instead being required to use sub-optimal payment, transaction, and other data processing mechanisms, which leads to inefficient data processing, security issues caused by incorrect computing service usages, and wasted system resources when multiple processors are invoked.

To address these issues, in various embodiments as discussed herein, an online transaction processor may provide operations that allow for faster checkout that enables TTP and other payment processing for consumer-side (e.g., the device/application of a merchant's customer, as well as a transaction processor's customer) transaction generating. This may be used to enable a mobile application on a mobile device to provide transaction information to a merchant device, such as a transaction data structure, invoice, or another transaction/payment request and instrument generation, instead of relying solely on merchant device-side transaction generation and processing requests. During checkout, a payment terminal device or other computing system may provide users with an option to “tap” to process a payment, where the tap generally refers to an NFC or RFID tap that wirelessly communicates data over a short-range (e.g., 4-5 centimeters (cm) or less for NFC taps, which allows sharing of a small data payload between NFC devices and/or readers, however other distances are contemplated). Prior to or in response to the tap or other action that exchanges data via the short-range wireless communications between the user's mobile device (or other client device) and the merchant device, an invoice or other data structure or document that records transaction information that may be used for payment processing may be generated in the user's mobile application by the user. For example, the user's application may be used to set or establish the transaction data for the transaction. The user may do this by entering item information, including an item description, item ID, item cost, tax, tip, and other relevant transaction information.

Once the item information, tax information, or other information enabling a payment processing system of a transaction processor to process a payment has been entered to the user's mobile application, the user may select a TTP option, or other option that indicates an intent to transmit the transaction information and a payment instrument or payment authorization to the merchant device at the location of the user. The merchant device may include a transceiver to receive the information through a tap or other processes for short-range wireless communications, such as a payment terminal, connectable short-range devices, and the like. The mobile application of the user may transmit the item data and other information to a purchase service of the transaction processor. That purchase service may correspond to a first processor and/or processing stack, API, application, and/or other components of the transaction processor that may correlate purchase and sales information with payment IDs and other indicators of processed payments.

The purchase service may create a new purchase record for the transaction and the information entered to the application, where the purchase record may have a state of “initial” or other state that indicates a payment has been initiated but not yet processed. In some embodiments, the initial state may also indicate that the merchant has not yet requested payment. The purchase service, with the record, may generate a new purchase ID and return the purchase ID to the mobile application on the mobile device of the user. This purchase ID may be configured to be usable with the TTP processes and be transmittable via short-range wireless communications. A software development kit (SDK) provided by the transaction processor and used in or with the mobile application may enable the mobile application to utilize TTP with merchant devices and/or payment terminals including those that are configured for use with the transaction processor. The mobile application may use the SDK to transmit the purchase ID to the merchant device via the TTP process and component, where a consumer ID, payment/wallet ID, user/device ID, or the like may also be conveyed, via a reference tag or the like, to the merchant device to designate a source or origin of the payment, such as the payment instrument to use for the payment and/or the user providing the payment.

For example, a user may provide payment in this manner using a digital account that may be established by providing account details, such as a login, password (or other authentication credential, such as a biometric fingerprint, retinal scan, etc.), and other account creation details. The account creation details may include identification information to establish the account, such as personal information for a user, business or merchant information for an entity, or other types of identification information including a name, address, and/or other information. The user may also be required to provide financial information, including digital account (e.g., credit/debit card) information, bank account information, gift card information, benefits/incentives, and/or financial investments, when processing transactions with merchants and/or other users or entities. Account creation may also be used to establish account funds and/or values, such as by transferring money into the account and/or establishing a credit limit and corresponding credit value that is available to the account and/or card. The transaction processor or other service provider may provide computing services to send, store, and receive money, process financial instruments, and/or provide transaction histories. The transaction processor may also provide for tokenization of data for transaction processing. The application or website of the transaction processor, such as PayPal® or other online payment provider, may provide payments and the other transaction processing services. Moreover, the digital account may be utilized through one or more mobile applications for mobile devices or other software applications.

In order to pay for the transaction using the account (e.g., a transfer or payment to another user, merchant, or other entity), the user may provide the consumer/customer ID with the purchase ID, as well as any further information necessary to indicate an origin of a payment for payment processing. The purchase ID, consumer/customer ID, and the like may be broadcasted when transmitted using an NFC standard and message embedding that causes a transmission via the TTP process. By utilizing short-range wireless communications (e.g., NFC communications limited to 4-5 cm of distance), theft of the purchase ID, as well as any other information, may be prevented or limited. Furthermore, any device being placed in such a proximity during transmission would be able to be seen by the merchant, user, or another to take action to prevent access, identify the user, or take other steps to prevent misappropriation of data and potential fraud.

Thus, payment may be made via short-range wireless communications (e.g., contactless payments via NFC, RFID, etc.) using the purchase ID, as well as consumer or customer ID. In some embodiments, the mobile application and/or device may provide other information to troubleshoot issues associated with purchase ID transmission, such as by requesting that the user turn on NFC or other short-range wireless compatible components on the user's mobile device, bring the device within a certain proximity, and the like. If failures continue, the merchant and/or user may select an option for other transmission, such as a displayable code and encoded data (e.g., a Quick Response (QR) code). This may occur after prompting by the device if the process to wirelessly transmit the data fails a number of times or after a certain period of time. In this regard, a code may be captured by a camera or other code scanner and may include encoded data for purchase and/or consumer/customer ID. A display component may display the code, and the user's device may then capture the code to receive the purchase and/or consumer/customer ID.

The first processor may then pass a payment request and/or message to a second processor and/or processing component(s), such as a payout processor of the transaction processor. The payout processor may be a standardized payment processor that may be configured for payment processing with multiple different payment mechanisms. In this regard, the first processor (e.g., a purchase and sales data processor) may utilize the payout processor for payment processing, but may be required to correlate the purchase and sales data from the mobile application and merchant device to the eventual payment processing and payment ID. As such, a payment message may be passed to a payout messaging queue, which may be consumed by and processed using a central payment processor system and components. These components may be used for payment instrument processing, such as payment card (e.g., credit/debit card) processing, and may invoke internal components, as well as payment networks and external financial institutions and payment processors.

Once the payment has been successfully processed and provided to the merchant, or account of the merchant, a payment ID may be generated that identifies the payment having been completed and provides a record of payment processing. The payment ID may be passed back to the purchase service through sending information indicating payment completion to a purchase message queue. Further, the payment ID may be returned to the mobile application, which will mark the purchase as paid with the first service (e.g., purchase and sales service), as well as with the mobile application. With the paid purchase record, the purchase and sales service may update the record to indicate “paid” instead of “initiated”, “payment pending”, or the like, and the record may then designate the transaction and completed based on the processed payment and payment ID. The purchase and sales service may also create a message that is sent to the to the purchase message queue that may be consumed later by the central payment processor. Consuming the message from the purchase and sales service may include processing the record, which includes the purchase information, as well as the payment ID. As such, the record may be correlated to the payment processing record and information through the payment ID, and the purchase and sales information may be stored with the payment information and record that can be passed to a more persistent transaction record system, as well as used for different messaging, information services, and the like.

In this manner, compatibility between different processing components may be effectuated through correlation of identifiers for data processing by different processors and in different messaging queues and storage components. This allows for more compatible internal systems and components of service providers, thereby increasing the availability of different computing services and providing more comprehensive and useful computing services and digital products. Additionally, by enabling the use of certain data transmission and processing operations between previously incompatible processors and components, a service provider's computer system may provide faster and more efficient data handling and processing for specific data processing requests, eliminating the need for multiple different processors and manual efforts to coordinate usage of those different processors. Therefore, a transaction processor's, or another service provider's, computer system and architecture, may be improved to provide previously unattainable computing services and data processing availability, while securely, efficiently, and reliably handling new requests and workloads.

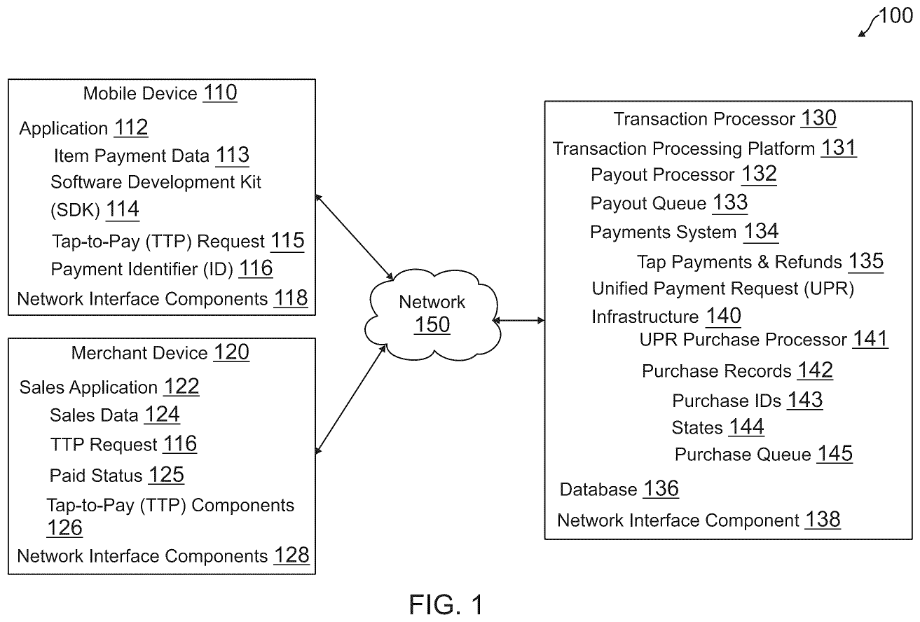

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a mobile device 110, a merchant device 120, and a transaction processor 130 in communication over a network 150. Mobile device 110 may be used to initiate a transaction and provide a payment instrument for a payment for the transaction using an application 112, which may be generated consumer- or customer-side instead of on merchant device 120. In this regard, when the transaction is processed, the transaction data may be provided to merchant device 120 through a TTP process and/or short-range wireless communications, which may be facilitated through processes to integrate and provide compatibility between processors, messaging queues, IDs, and data storage by transaction processor 130. Merchant device 120 may then process the transaction from the data received from mobile device 110.

Mobile device 110, merchant device 120, and transaction processor 130 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

Mobile device 110 may be implemented using any appropriate hardware and software configured for wired and/or wireless communication with merchant device 120, transaction processor 130, and/or other devices, servers, and computer systems. In this regard, mobile device 110 may interact with merchant devices and/or systems, which may include POS devices, payment terminals, contactless payment transceivers and devices, for processing a transaction through TTP processes. Mobile device 110 may correspond to a user that may generate purchase and sales data through an executable software application, which may be transmitted to merchant device 120 via the TTP processes and/or short-range wireless communications. In various embodiments, mobile device 110 may be implemented as a personal computer (PC), a smart phone, laptop/tablet computer, wristwatch with appropriate computer hardware resources, other type of wearable computing device, and/or other types of computing devices capable of transmitting and/or receiving data. Although only one computing device is shown, a plurality of computing devices may function similarly.

Mobile device 110 of FIG. 1 contains an application 112 and a network interface component 118. Application 112 may correspond to executable processes, procedures, and/or applications with associated hardware. In other embodiments, mobile device 110 may include additional or different modules having specialized hardware and/or software as required.

Application 112 may correspond to one or more processes to execute software modules and associated components of mobile device 110 to provide features, services, and other operations for a user over network 150, which may include accessing and utilizing computing services provided by transaction processor 130 for processing in-application data for a transaction with merchant device 120 using TTP processes. In this regard, application 112 may correspond to specialized software utilized by a user of mobile device 110 that may be used to access a website or application (e.g., mobile application, rich Internet application, or resident software application) that may display one or more user interfaces (UIs) that allow for interacting with the computing services of transaction processor 130. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 150, including retrieving website information, presenting the website information to the user, and/or communicating information to the website. As such, application 112 may be used to access a website to initiate or generate a transaction through input of item data, purchase and sales data including tax and tip data, and the like, which may then be requested to be transmitted to merchant device 120 through a TTP process. However, in other embodiments, application 112 may instead correspond to a dedicated or mobile software application of transaction processor 130, a merchant, or another entity, which may provide processes for transaction data entry and payment through the TTP process with merchant device 120.

Application 112 may be associated with account information, user financial information, and/or transactions including item payment data 113. However, in further embodiments, different services may also be provided via application 112, including other transaction processing and/or payment services available via transaction processor 130. When utilizing application 112 with transaction processor 130, application 112 may request processing of a transaction based on item payment data 113, such as through a payment request transmitted to transaction processor 130 based on entered item, sales, tax, tip, and other information, which may be provided as input and populated in one or more application interfaces and/or other Uls, added or include in a form or invoice, including a payment request UI and/or form, or the like. Thereafter, the user may select an option, button, or command in application 112, which may request processing through a TTP process and/or short-range wireless communications, which may then cause application 112 to interface with transaction processor 130 for purchase ID generation. Application 112 may utilize an SDK 114 to provide the transaction generation and/or payment request processing forms and operations in application 112, such as those to interface with transaction processor 130.

Application 112 may interface with transaction processor 130 to generate a purchase ID for item payment data 113 entered to application 112, which may be transmitted wirelessly to merchant device 120. Transaction processor 130 may generate the purchase ID and provide it to application 112, which may transmit the purchase ID with a customer or consumer ID, such as an account, device, or user ID, to merchant device 120 for payment processing, where the transmission may use short-range wireless communications that may occur between mobile device 110 and merchant device 120 at a physical merchant location. The purchase ID or other data may be transmitted wirelessly via a TTP request 115, such as through short-range wireless communications for contactless or short-range payment protocols, devices, and technology, to merchant device 120 and/or a component or peripheral of merchant device 120, such as a POS device, payment terminal, wireless transceiver, or other merchant system or device component capable of short-range wireless communications. An SDK 114 may be used to transmit TTP request 115 to merchant device 120 based on one or more coded software processes or operations that may be provided via SDK 114 and implemented in application 112. Application 112 may be used to view the results of transaction processing and the like via one or more interfaces, such as a payment ID 116 received back from transaction processor 130 in response to processing a payment, where payment ID 116 may be used to document, record, and verify the payment has been processed (e.g., as a proof of payment, receipt, and/or transaction history).

In various embodiments, mobile device 110 includes other applications as may be desired in particular embodiments to provide features to mobile device 110. For example, the other applications may include security applications for implementing client-side security features, programmatic client applications for interfacing with appropriate application programming interfaces (APIs) over network 150, or other types of applications. The other applications may also include email, texting, voice and IM applications that allow a user to send and receive emails, calls, texts, and other notifications through network 150. In various embodiments, the other applications may include financial applications, such as banking applications. Other applications may include social networking applications, media viewing, and/or merchant applications.

The other applications may also include location detection applications, which may be used to determine a location for the user, such as a mapping, compass, and/or GPS application, which can include a specialized GPS receiver that determines location information for mobile device 110. The other applications may include device interface applications and other display modules that may receive input from the user and/or output information to the user. For example, the other applications may contain software programs, executable by a processor, including a graphical UI (GUI) configured to provide an interface to the user. The other applications may use components of mobile device 110, such as display devices capable of displaying information to users and other output devices, including speakers.

Mobile device 110 may further include or have access to a database, which may correspond to different types of data storage and components including cloud computing storage nodes, remote data stores and database systems, distributed database systems over network 150, and the like used to store various applications and data. The database may store various applications and data and be utilized during execution of various modules of mobile device 110. The database may include, for example, IDs such as operating system registry entries, cookies associated with application 112 and/or the other applications, IDs associated with hardware of mobile device 110, or other appropriate IDs, such as IDs used for payment/user/device authentication or identification, which may be communicated as identifying the user/mobile device 110 to transaction processor 130.

Mobile device 110 includes at least one network interface component 118 adapted to communicate with transaction processor 130 and/or other devices and servers over network 150. In various embodiments, network interface component 118 may include a WiFi component, a DSL (e.g., Digital Subscriber Line) modem, a PSTN (Public Switched Telephone Network) modem, an Ethernet device, a broadband device, a satellite device and/or various other types of wired and/or wireless network communication devices. Network interface component 118 also includes at least one short-range transceiver adapted to communicate with merchant device 120 and/or other nearby devices, transceivers, and/or components through short-range wireless signaling and communications including NFC communications, RFID communications, Bluetooth, WiFi, infrared scanners and/or communicators, and the like. In various embodiments, the short-range transceiver may correspond to microwave, RF, infrared, Bluetooth, and NFC devices and components, including components that enable TTP communications with merchant device 120.

Merchant device 120 may be implemented using any appropriate hardware and software configured for wired and/or wireless communication with user devices including mobile device 110, and may correspond to merchant devices, POS devices and registers, payment terminals, contactless payment transceivers and devices, and the like used for processing a transaction. Merchant device 120 may correspond to a merchant and/or merchant employee that processes payments and sales at a physical merchant location. In various embodiments, merchant device 120 may be implemented as a personal computer (PC), a payment terminal device with payment processing components, a smart phone, laptop/tablet computer, wristwatch with appropriate computer hardware resources, other type of wearable computing device, and/or other types of computing devices capable of transmitting and/or receiving data. Although only one device is shown, a plurality of device may function similarly.

Merchant device 120 of FIG. 1 contains a sales application 122, TTP components 126, and a network interface component 128. Sales application 122 may correspond to executable processes, procedures, and/or applications with associated hardware. In other embodiments, merchant device 120 may include additional or different modules having specialized hardware and/or software as required.

Sales application 122 may correspond to one or more processes to execute software modules and associated components of merchant device 120 to provide features, services, and other operations for payment processing over network 150 with transaction processor 130. These features, services, and other operations may include processes to request payment for a purchase ID provided by mobile device 110 using a TTP interaction. The purchase ID may identify and/or reference a transaction, invoice, or the like, and may further be sent and/or combined with an ID of the customer, consumer, or other user that may correspond to and/or be used to identify the source or origin of a payment instrument usable to process a payment for the transaction. In this regard, sales application 122 may correspond to sales and/or payment processing software utilized by a user of merchant device 120, such as a merchant owner, employee, agent, or the like of a merchant entity. The sales and/or payment processing software may display one or more Uls that allow for interaction with the computing services of transaction processor 130 for payment processing.

In various embodiments, sales application 122 may correspond to a general browser application configured to retrieve, present, and communicate information over the Internet (e.g., utilize resources on the World Wide Web) or a private network. For example, sales application 122 may provide a web browser, which may send and receive information over network 150, including retrieving website information, presenting the website information to the user, and/or communicating information to the website. The website may provide processes for payment processing via transaction processor 130. However, in other embodiments, sales application 122 may include a native and/or dedicated software application of transaction processor 130, a merchant system or merchant device, or other entity.

Sales application 122 may include payment operations, which may be used to process payments with users. For example, payment operations may be used to receive and/or generate a transaction to purchase one or more items or services, such as by receiving item or service input and selection through item scanning, menu or interface selections and input, receipt of a transaction or order from another device or server, and the like. Commonly, transactions may be generated at sales application 122 and requested for processing. However, as discussed herein, mobile device 110 may generate the transaction and/or provide item payment data 113 via a purchase identifier, such that mobile device 110 is the origin of the transaction and sales application 122 may instead request processing of the transaction through processing a purchase ID and additional ID, token, or the like provided with the purchase identifier. As used herein, the purchase identifier is usable to determine a payment instrument for the transaction, such as a source or origin of a payment for the transaction.

In this regard, sales data 124 may be received from a TTP request 115, and may correspond to a purchase ID, as well as any data retrievable from transaction processor 130 and/or provided via TTP request 115. For example, sales data 124 may include the purchase ID and a consumer or customer ID usable as a payment instrument or to identify a payment instrument. Sales data 124 may also include any item, tax, tip, or other cost and/or corresponding product or service to be provided when the cost is paid. TTP request 115 may correspond to communications and data transmissions occurring over short-range wireless communications. For example, a card reader (e.g., magnetic stripe reader, EMV or RFID chip reader, etc.), contactless payment terminal, or the like may be configured to accept payment data and other short-range wireless communications from mobile application payments from mobile devices (e.g., via NFC, RFID, QR code scanning, etc.).

Sales application 122 may utilize TTP components 126, such as contactless payment devices, terminals, transceivers, or the like, to receive TTP request 115. In response, a payment request may be sent to transaction processor 130, which may process the purchase ID and corresponding payment instrument. Once a payment has been completed and a payment ID generated for the completed payment, the payment ID, receipt, or other data for a transaction history may be sent back to sales application 122, which may be updated with a paid status 125. Paid status 125 may therefore provide the results of transaction processing and the like via one or more Uls, which may include a receipt or other transaction history that may be transmitted to mobile device 110.

TTP components 126 of merchant device 120 may be used to provide additional functionality and assist in transaction and payment processing, such as wireless communications within a short-range, proximity or proximity range, and/or locally over short-range wireless communications. In this regard, TTP components 126 may include data readers, which may be configured to read data from payment cards, gift cards, mobile devices, key fobs, and the like. The data readers may read and determine payment data using magnetic stripe readers, EMV chip readers, NFC card of fob device readers, and the like. These data readers may be used for TTP processes, such as those where a device is brought within 4-5 cm of merchant device 120 and/or for NFC/RFID transmissions.

Merchant device 120 may further include a database stored on a transitory and/or non-transitory memory of merchant device 120, which may store various applications and data and be utilized during execution of various modules of merchant device 120. The database may include, for example, IDs such as operating system registry entries, cookies associated with sales application 122 and/or the other applications, IDs associated with hardware of merchant device 120, or other appropriate IDs, such as IDs used for payment/user/device authentication or identification. IDs may be communicated as identifying the merchant and/or merchant device 120 to transaction processor 130. Moreover, the database may include sales data 124 and other data provided to merchant device 120 from mobile device 110 for transaction processing. Sales data 124 may be stored by merchant device 120 until transaction processing is completed.

Merchant device 120 includes at least one network interface component 128 adapted to communicate with transaction processor 130 and/or other devices and servers over network 150. In various embodiments, network interface component 128 may include a WiFi component, a DSL (e.g., Digital Subscriber Line) modem, a PSTN (Public Switched Telephone Network) modem, an Ethernet device, a broadband device, a satellite device and/or various other types of wired and/or wireless network communication devices. Network interface component 128 also includes at least one short-range transceiver adapted to communicate with mobile device 110 and/or other nearby devices, transceivers, and/or components through short-range wireless signaling and communications including NFC communications, RFID communications, Bluetooth, WiFi, infrared scanners and/or communicators, and the like. In various embodiments, the short-range transceiver may correspond to microwave, RF, infrared, Bluetooth, and NFC devices and components, including components that enable TTP communications with mobile device 110.

Transaction processor 130 may be maintained, for example, by an online service provider, which may provide processes to provide transaction processing and payment services through different transaction and payment processors and components. In this regard, transaction processor 130 includes one or more processing applications which may be configured to interact with merchant device 120, mobile device 110, and/or another device/server to facilitate communications for transactions, payment processing, and the like. In this regard, integration and compatibility between payment processing components may be facilitated and improved, as discussed herein, using the processes to correlate purchase and sales data with payout and payment data. Transaction processor 130 may be maintained by or correspond to an online service provider, for example, PAYPAL®, Inc. of San Jose, CA, USA, however, other types of service providers may also utilize the processes described herein.

Transaction processor 130 of FIG. 1 includes a transaction processing platform 131, a database 136, and a network interface component 138. Transaction processing platform 131 may correspond to executable processes, procedures, and/or applications with associated hardware. In other embodiments, transaction processor 130 may include additional or different modules having specialized hardware and/or software as required.

Transaction processing platform 131 may correspond to one or more processes to execute software modules and specialized hardware of transaction processor 130 to process transactions for items on behalf of users and merchants, such as a transaction between mobile device 110 and merchant device 120, where mobile device 110 may generate transaction data for processing a transaction in-person using short-range wireless communications and/or contactless payments, data transfers, communications, and the like. In this regard, transaction processing platform 131 may correspond to hardware and/or software used by users to establish accounts and/or engage with electronic transaction processing services. Accounts may each be created by providing personal and/or financial information to transaction processor 130 and selecting authentication credentials. In various embodiments, the financial information may include payment instrument information, such as account/card numbers and information. An account may be used to purchase items and/or transfer funds. The payment account may be accessed and/or used through a browser application and/or dedicated payment application. Transaction processing platform 131 may process a payment and may provide a transaction history for transaction authorization, approval, or denial.

Transaction processing platform 131 may correspond to a computing service and/or digital product, available over network 150, provided by transaction processor 130, which may be utilized by end users to perform electronic payments, transfers, and the like using one or more accounts and/or financial instruments. Transaction processing platform 131 may also include or utilize different processors, engines, or models as required during transaction and/or payment process for authentication, account setup and maintenance, electronic transaction processing, deposit and/or withdrawal, dispute resolution, and the like. Transaction processing platform 131 may include one or more applications, APIs, API integrations, and the like with merchant device 120 and/or payment networks in order to detect, receive, and monitor transaction data for approval and/or declination.

Transaction processing platform 131 may process a transaction through different processing stacks, components, systems, and processors. For example, transaction processing platform 131 includes a payout processor 132, which may correspond to a standard, generalized, or most commonly used processor of payments between parties, entities, and the like. For example, payout processor 132 may be commonly invoked for transaction processing to provide a payment from one party to another in the transaction, such as a payment from a customer to a merchant. In this regard, payout processor 132 may provide computing services to users and/or may correspond to a backend processing component configured to process payments on behalf of the frontend applications and components of those computing services for electronic transaction processing and/or account services. In this regard, payout processor 132 may process payments and payout funds or values to users, sellers, merchants, and the like in response to receiving transaction data for electronic transaction processing of transactions using digital accounts or other payment instruments.

In some embodiments, payout processor 132 or a frontend component, such as an account services and/or transaction processing application, may be used by users, such as a user associated with mobile device 110, to establish user and/or payment accounts, as well as digital wallets, which may be used to process transactions. Accounts may be accessed and/or used through one or more instances of a web browser application and/or dedicated software application executed by mobile device 110 and engage in computing services provided by transaction processing platform 131. Computing services of transaction processing platform 131 may also include or instead correspond to messaging, social networking, media posting or sharing, microblogging, data browsing and searching, online shopping, and other services available through transaction processor 130.

When a transaction is requested to be processed, payout processor 132 may be invoked to process the transaction using a payment instrument. This may include reading or receiving transaction and/or payment data from a payout queue 133, which may correspond to a messaging queue where messages related to payments and other payouts of funds, money (fiat and crypto), or other values may be processed in an order and/or based on when the requests and/or messages are received at payout queue 133. The messages from payout queue 133 may be ingested in a particular order by a payments system 134, which may perform backend processing and communications with financial service providers, accounts, payment instrument providers and network, and the like to effectuate a payment from a payment instrument to an account of a merchant or other payee. Payments system 134 may include processes to generate payment IDs, such as payment ID 116 provided to mobile device 110 to indicate or verify the payment has been processed. Payment ID 116 may provide a proof of payment, and payments system 134 may also provide a transaction history, such as a receipt, or other data that may be stored in conjunction with the payment ID. Tap payments and refunds module 135 may be used to manage these payments and payment processing, which may include data storage. As such, tap payments and refunds module 135 may ingest the messages of payout queue 133 for processing, which may then include executing one or more payment processes to have funds withdrawn from the user's account and paid the merchant's account. Tap payments and refunds module 135 may also correlate the payment ID with a purchase ID or other ID for a record of purchase and sales data, such as item payment data 113, to the payment ID and payout or payment processing record.

A unified payment request (UPR) infrastructure 140 may correspond to a payment and/or data processor, or other processing component, of transaction processing platform 131, which may include executable software and/or specialized hardware of transaction processor 130. UPR infrastructure 140 may be used to process transactions through purchase and sales data received from client devices of users, such as mobile devices including mobile device 110 and/or other user devices. In this regard, UPR infrastructure 140 may process input purchase and sales data from application 112, such as item payment data 113, using a UPR purchase processor 141. UPR purchase processor 141 may correspond to a processing component and/or stack that may be configured to process incoming payment requests. A payment request may include a purchase ID that identifies a transaction record or other data record for transaction data generated by or using application 112. In contrast to this processes where the transaction data originates from application 112 on mobile device 110, conventional generation of transaction data occurs at merchant device 120. When purchase requests are initiated at mobile device 110, and an indication to process the data via TTP request 115 exchangeable between mobile device 110 and merchant device 120 is transmitted to transaction processor 130 using SDK 114 of application 112.

Purchase records 142 may be generated for purchase and sales data received, and purchase IDs 143 may be generated for purchase records 142 to uniquely identify purchase records 142. For example, each one of purchase records 142 may have a corresponding one of purchase IDs 143 that allows for unique identification of a transaction. States 144 may indicate a completion state and/or purchase and payment status, such as whether the record is initiated, in an initial or open state, has been paid, and/or payment has been processed and the purchase completed. States 144 may be updated based on whether payment has been processed by payout processor 132 and whether payments system 134 has issued a corresponding payment ID. Once a payment ID has been received for one of purchase records 142, a corresponding one of states 144 that may be in an “initial” or “payment pending” state may be updated to reflect a “paid” state and status of the transaction.

As such, when item payment data 113 is received, one of purchase records 142 is generated with one of purchase IDs 143, which is sent back to application 112 for transmission via TTP request 115 to merchant device 120. UPR purchase processor 141 may then process a payment using a consumer or customer ID received with the purchase ID, or other designation of a payment instrument. Payment may be processed by triggering a payout message to payout queue 133, which may be ingested by payments system 134 for processing. A payment ID may be received and a purchase queue 145, such as another messaging queue of purchase processor 141, may be utilized so that a message for the “paid” and/or completed purchase record is processed by payments system 134 for storage with the payment ID and payment information. As such, purchase records 142, once completed, may be passed to payments system 134 for storage with payment information and corresponding payment IDs.

In various embodiments, additional applications and services may be provided to provide features to transaction processor 130. For example, the applications and services may include security applications for implementing server-side security features, programmatic client applications for interfacing with appropriate application programming interfaces (APIs) over network 150, or other types of applications. The applications and services may contain software programs, executable by a processor, including a graphical user interface (GUI), configured to provide an interface to the user when accessing transaction processor 130 via one or more of merchant device 120 and/or mobile device 110, where the user or other users may interact with the GUI to view and communicate information more easily. In various embodiments, the applications and services may include additional connection and/or communication applications, which may be utilized to communicate information to over network 150.

Additionally, transaction processor 130 includes or may access database 136. Database 136 may store various IDs associated with mobile device 110. Database 136 may also store account data, including payment instruments and authentication credentials, as well as transaction processing histories and data for processed transactions. Database 136 may store received data associated with a user, such as transaction data, as well as purchase and payment IDs. As such, database 136 may be used to store records of purchase and sales data that is received and processed, as well as matched to payments made based on processing the purchase and sales data. For example, payment ID 116 may be stored with a corresponding one of purchase records 142 and/or purchase IDs 143 to record transaction and payment data for auditing, review, returns, and the like. Although database 136 is shown as residing on transaction processor 130 as a database, in other embodiments, other types of data storage and components may be used including cloud computing storage nodes, remote data stores and database systems, distributed database systems over network 150 and/or of a computing system associated with transaction processor 130, and the like.

In various embodiments, transaction processor 130 includes at least one network interface component 138 adapted to communicate with mobile device 110, merchant device 120, and/or another device/server over network 150. In various embodiments, network interface component 138 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

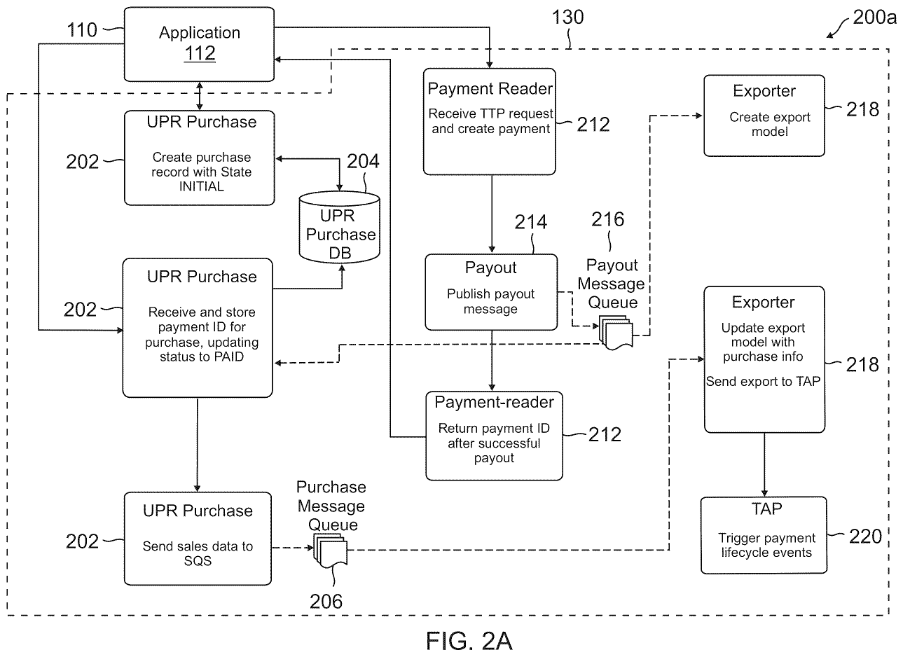

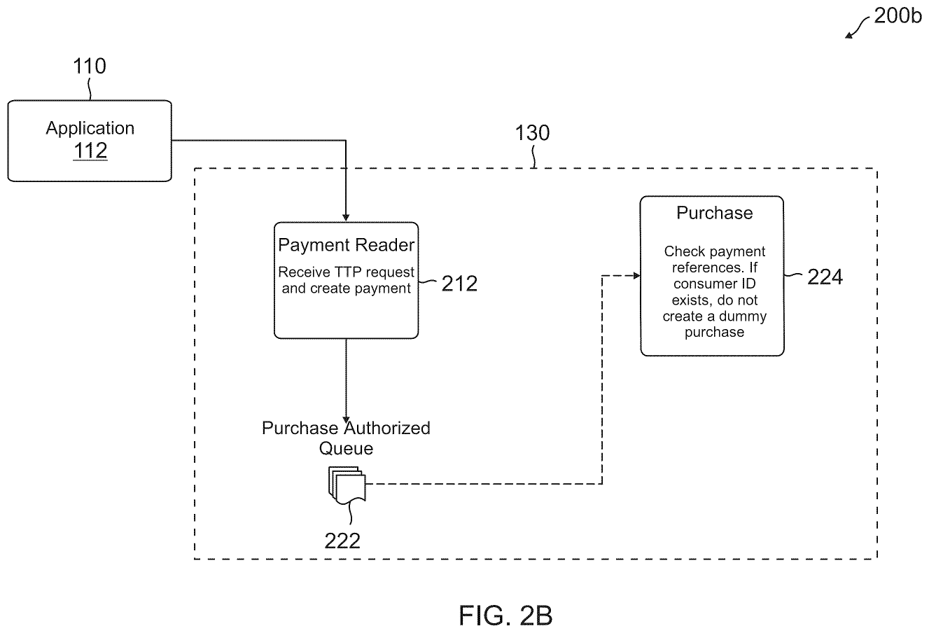

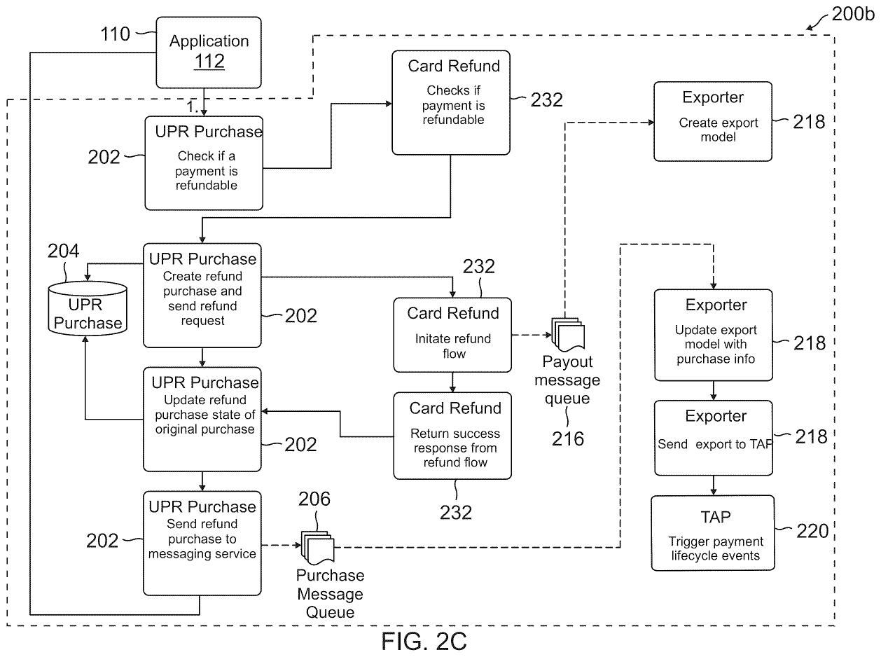

FIGS. 2A-2C are exemplary diagrams 200a-200c of system components and processing flows that may be used when providing a tap-to-pay service for merchant invoicing between multiple data processing queues, according to an embodiment. Diagram 200a-200c of FIGS. 2A-2C display hardware and software components of application 112 on mobile device 110 interacting with transaction processor 130 to perform a TTP payment using a transaction and/or purchase and sales data input and/or generated in application 112 instead of at merchant device 120, wherein mobile device 110, application 112, merchant device 120, and transaction processor 130 are discussed in reference to system 100 of FIG. 1. In this regard, transaction processor 130 in diagrams 200a-200c include components of transaction processing platform 131 and UPR infrastructure 140.

In diagram 200a, different interactions between components are shown in a processing flow used to process transactions generated or input in application 112 through TTP processes and mechanisms with merchant device 120. Initially, application 112 may be used to create, generate, and/or input a transaction, which may correspond to a user utilizing mobile device 110 to input purchase and sales data for a payment request to be processed with merchant device 120. The transaction may be for purchase of items and/or services from a merchant. The merchant or an employee of the merchant utilizing merchant device 120 may request and/or accept payment for the transaction via a TTP process where mobile device 110 may be brought into a proximity range, such as a few millimeters or centimeters where short-range wireless communications may be exchanged using a corresponding short-range wireless communication protocol, mechanism, and/or technique. For example, NFC, RFID, or other short-range wireless communications may allow two nearby devices (e.g., within a wireless proximity range or distance) to send and receive data in local, fast, and secure data exchanges. In some embodiments, an NFC data exchange format (NDEF) may be utilized, which may correspond to a standardized data format specification used for NFC data transmissions. NDEF may be used to encode actions to NFC tags and/or exchange data between devices, which allow generating, transmitting, and/or reading NDEF messages by and between devices. However, other messaging protocols and formats may also be used.

Initially, a user may want to carry out a payment in application 112, which is configured to interact with a merchant device and/or peripheral, component, or transceiver of the merchant device. Transaction processor 130 may include a first processor configured to receive and process purchase requests and data from application 112, as well as a second processor configured to receive and process payment requests and data from a merchant device. Conventionally, these processors, processing stacks, and/or other components do not interact and therefore do not have compatibility. However, for TTP for transactions generated at mobile device 110, the two processors, the purchase processor and the payment processor, are required to interact and therefore require a mechanism to enable interactions for data processing, and ideally, a mechanism that enables efficient, accurate, ad reliable interactions for the data processing.

As such, a user may first use application 112 to enter purchase and sales data for a transaction, such as item data, tax and/or tip data, or other data associated with the items/services to be purchased and amount of the purchase. Once entered, the user may select a TTP option and application 112 may send a purchase order, request, invoice, or other form and/or data to a UPR purchase processor 202, which may create a new purchase record having a purchase ID and a record or payment state of “INITIAL”, “PAYMENT PENDING”, “OPEN”, or the like. UPR purchase processor 202 may transmit the generated purchase ID back to application 112 for handling via the TTP mechanism and short-range wireless communications. Further, a UPR purchase database 204 may receive the generated purchase ID for storage, which may be accessible by UPR purchase processor 202 for further processing of the purchase ID. UPR purchase database 204 may be used to store data records for the user/consumer-side transactions that have been generated at application 112. Data records may correspond to purchase records for the transactions.

Application 112 may receive the purchase ID and may use an SDK to send a TTP request to a payment reader, payment processing peripheral, transceiver, or the like for the merchant device, which may include a reference tag with a key consumer ID or another ID that may be used to dictate and identify an origin or source of a payment. In some embodiments, the ID may correspond to or be associated with a payment instrument and/or digital token representing the payment instrument. These processes may utilize the purchase and sales data processor of transaction processor 130. This payment reader may be in communication with and/or may call a payment reader API 212 for payment processing. In this regard, application 112 and payment reader A PI 212 may have capabilities to interact for payment processing via TTP processes as shown in diagrams 200a and 200b, and may also be configured for additional payment processing including requesting and processing a refund, as shown in diagram 200c.

Once application 112 has transmitted the purchase ID, and any payment ID or instrument, to the merchant device, the payment processor may be invoked by the merchant device. The merchant device may transmit a payment request to an A PI, gateway service, and/or the like of the payment processor of transaction processor 130, such as payment reader API 212 that may be called by the payment reader or other payment peripheral that received the purchase ID by the TTP process and interaction with mobile device 110. Payment reader API 212 may receive the TTP payment request having the purchase ID for processing, as well as the consumer ID or another ID usable for payment processing and/or as the payment instrument. Payment reader API 212 may create a request for a payout 214, which is provided to a payout processor for processing an amount or value for a payment to be made from an account of a user to an account of the merchant. The payout processor may correspond to a core or central payment processor system of the online transaction processor. An integration with this core payment processor by UPR purchase processor 202, payment reader 212, and/or other component of the computing system for TTP payments to be processed shown in diagrams 200a-c may allow for processing of payout 214.

Thus, payout 214 including an amount and/or other payment details may be processed by the core payment processor using an internal messaging queue and messages transmitted between the internal computing systems of the transaction processor. Payout 214 may be published as a message to a payout messaging queue 216, which may correspond to a data messaging queue that organizes, holds, and temporarily stores messages between system components for handling by downstream processors. The handling and processing may occur during batch processing and/or based on a sequence in payout messaging queue 216. An exporter service 218 may ingest these messages and export to payments system 134, which may create an export model of the data and provide to a payment processing system connected to one or more payment networks, financial institutions, or the like to resolve payment. Exporter service 218 may correspond to an internal service and/or connection that connects UPR purchase processor 202 and associated systems, components, and the like to a main or “core” payment processor, which may serve as the integration between those systems. As such, exporter service 218 may provide a connection to exchange messages between different computing systems, sub-systems, and/or components of a computing architecture of a service provider. For example, in diagrams 200a-200c, exporter service 218 may provide an integration with a system for TTP payment processing at POS devices and/or payment terminals with the core payment processor of a transaction processor. Exporter service 218 may further transform payment and purchase information for consumption by the core payment processor.

Once the payment message has been passed to payout message queue 216 and consumed by exporter service 218, a TTP export record may be generated. This includes passing the payment message back to UPR purchase processor 202, where, conventionally, a dummy purchase is created in the original flow of the purchase and/or payment processor. However, since a purchase record exists, this dummy purchase does not need to be created, and UPR purchase processor 202 may instead wait for a payment ID that provides proof of payment processing and payout and may also identify the payment and/or payment information from payment processing by payments system 134 and/or corresponding database or storage of payment IDs and information used by payments system 134.

When the payment is successfully completed and payout has been performed to an account of the merchant, the payment ID may be passed back from payments system 134 to UPR purchase processor 202. UPR purchase processor 202 therefore receives the payment ID for the purchase and may store the payment ID with the purchase record having the purchase ID, or may update the purchase record to include the payment ID with the purchase ID in the same record. This is performed by UPR purchase processor 202 so that the two IDs are correlated by the purchase record as corresponding to the same transaction and/or purchase. When doing so, UPR purchase processor further updates the status of the purchase record. For example, UPR purchase processor 202 may update the status of the purchase record to “PAID”, “COMPLETED”, or the like, and UPR purchase processor 202 may send the payment ID back to application 112. With the paid purchase record, UPR purchase processor 202 may then create a message for a purchase message queue 206, which may identify the purchase record and/or purchase ID. The message may be published and may be consumed by exporter service 218 from a request, queue, or the like for processing and handling including updating of data records so that the purchase record is stored alongside the payment ID and payment information.

As such, exporter service 218 may store the purchase information next to or with the payment information and pass the correlated and linked information to a TAP API 220 for triggering of payment lifecycle events. TAP API 220 may correspond to an API of a central payment processor system and components that may be used by the system for UPR purchase processor 202 and corresponding TTP payments to process payments using different payment instruments, payment networks, and/or financial instruments. TAP API 220 may therefore consume messages from exporter service 218 and pass those messages to the various systems, components, applications, and/or processors of the core payment processing system for processing, such as by recording a payment, charging the payment to an account, payouts to accounts, etc.

Referring now to FIG. 2B, diagram 200b shows an exemplary flow of the data processing interactions that ensure proper and resilient synchronization of payment and purchase data. For example, in diagram 200a, it is discussed that, conventionally, a dummy purchase may be generated when the purchase ID is received back at UPR purchase processor 202. In a similar manner, an existing SDK or application processor may similarly create a dummy purchase for handling when TTP processes are used. This dummy purchase may conventionally be used within exporter service 218 when passing details to TAP API 220. However, with the processing flow shown in diagram 200b, payment reader API 212 instead receives the TTP request and interacts with a purchase authorized queue 222 and a purchases API 224 so that this dummy record is not needed or generated. Instead of using a dummy record, the consumer ID or other ID of the user and/or payment instrument may be used to detect if the consumer ID already exists. Purchases API 224 may consume a payment message with the consumer ID from purchase authorized queue 222 that has authorized a payout. Purchases API 224 then may check payment references for the consumer ID. If that consumer ID already exists in a corresponding record, the dummy purchase is not created.

Referring now to FIG. 2C, diagram 200c shows a return and/or refund using UPR purchase processor 202, where UPR purchase processor 202 may act as a mediator for card refunds and/or other refunds that may be performed through a TTP process and/or using the purchase ID and payment ID created as discussed in reference to diagram 200a. For a card or other payment refund, the additional components and interactions shown in the processing flow of diagram 200c may further be used. Application 112 may request a return or refund from UPR purchase processor 202 after a payment processed via application 112 or another payment application (e.g., where application 112 corresponds to a mobile application, such as one available to be downloaded and installed from the service provider, a mobile device provider's app store, etc. UPR purchase processor 202 may check if a refund is available using the purchase ID and based on any known policies, availability of funds to return, and the like. UPR purchase processor 202 may therefore be used for payment processing and may correspond to the service that manages and maintains the purchase information (e.g., what was purchased and other line-item information for a transaction) and its status.

As such, diagram 200c represents a “reverse payment” flow that may be used to issue a refund and/or return funds to the original payment instrument processed in diagrams 200a and 200b. Thus, certain components shown in diagram 200c may correspond to those in diagrams 200a and 200b that may include further functionality to process this “reverse payment” flow. To issue a refund, application 112 may call UPR purchase processor 202 with the purchase ID and request the refund based on the refund's availability. UPR purchase processor 202 may call a card refund service 232 to determine, based on any refund policies, guidelines, rules, and/or agreements, whether the refund is available, and what the terms of the refund are. For example, UPR purchase processor 202 may retrieve the payment ID using the purchase ID, and may call card refund service 232 or other refund service to check if the payment associated with payment ID is refundable. The payment associated with the payment ID may be refundable if the merchant and/or account allows refunds, the refund complies with a refund policy, and/or the amount is refundable based on the policy (e.g., inside a refund time window, is a refundable item/service, etc.). If not refundable, an error is sent back to application 112 for display.

If refundable, UPR purchase processor 202 may create a new purchase and purchase record, which may similarly be stored by UPR purchase database 204. The purchase record generated in this case, however, may be used to record the refund transaction. The refund record therefore provides an accounting of the refund and any necessary information for refund processing. UPR purchase processor 202 may call card refund service 232 to initiate the refund processing flow. When card refund service 232 is called, this service may trigger and publish a message for payout message queue 216 for the refund, which is consumed by exporter service 218. exporter service 218 then then similar create an export model of the data for exporting and processing.

When publishing the message to payout message queue 216, card refund service 232 may further initiate and execute the refund processing flow, such as a series of executable steps or operations to process a refund and have funds provided back to the purchaser from the original seller or merchant. Payments system 134 may aggregate the refund data and trigger the refund within TAP API 220. Card refund service 232 may then proceed with the refund processing flow, and when completed, a successful response from the refund flow may be returned. When a successful refund is completed and the response return, a success response for the refund is provided to UPR purchase processor 202 by card refund service 232. UPR purchase processor 202 may update the refund data record and/or the purchase state of the original purchase based on the refund. For example, the original purchase record and/or the refund record may be updated to identify the state of “REFUNDED” or “REFUND”. UPR purchase processor 202 may then send a refund purchase to a messaging service, which may publish the message for the refund and the refund purchase data to purchase message queue 206. exporter service 218 may further consumer the messages from purchase message queue 20 so that correlation of the purchase and payment IDs, as well as the current status of the purchase, may be stored for future auditing and/or transaction history information. In this regard, exporter service 218 may update the export model with the purchase information for the “refund purchase” data record, and may send an export of the data to TAP API 220, which may trigger payment lifecycle events. Further, application 112 may be updated with the corresponding refund information.

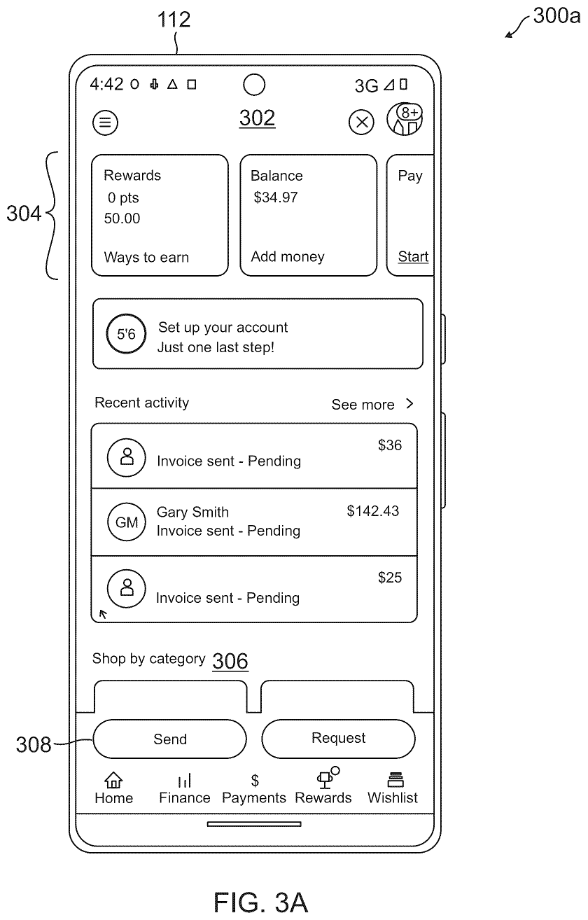

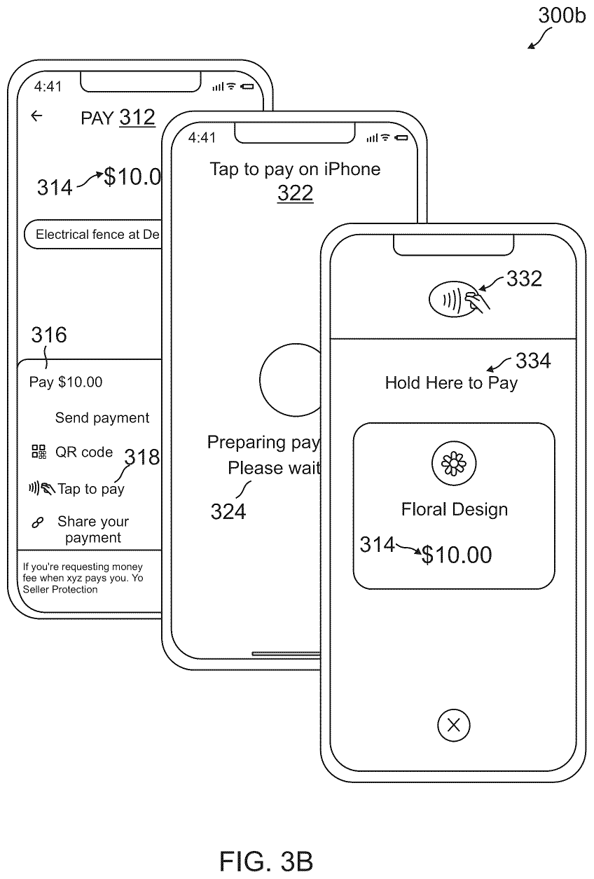

FIGS. 3A and 3B are exemplary user interfaces (UIs) 300a and 300b of a mobile application on a mobile device usable when performing tap-to-pay processing of merchant invoicing, wherein data processing requests are tracked between different processing queues by correlating IDs, according to an embodiment. UIs 300a and 300b display information that may be presented to a user when performing a TTP payment at a merchant location using transaction data generated on the user's device. As such, UIs 300a and 300b may be presented on mobile device 110 when interacting with merchant device 120 and/or transaction processor 130, discussed in reference to system 100 of FIG. 1, to facilitate short-range wireless transmission of purchase IDs and other data during TTP payment processing.

In UI 300a, application 112 is displaying an account dashboard 302 where a user may take different actions and/or engage with different processes and features provided by application 112 and/or the corresponding transaction processor, such as to access and utilize the digital products and computing services of the transaction processor. Account dashboard 302 includes account balances 304, which may be used to process one or more transactions. Additional account data may also be provided in account dashboard 302, such as account setup information, recent activity, and the like.

With regard to payment processing, a shopping option 306 may be provided where a user may engage in one or more processes to generate or initiate a transaction on mobile device 110. For example, in account dashboard 302, selection of shopping option 306 may allow a user to select one or more items for purchase and generate a bill, invoice, or other transaction record in application 112. The transaction record may require payment by the user to the corresponding merchant as part of the transaction processing, which the user may initiate using a send button 308 that conveys a TTP request. The TTP request corresponds to a send payment option, where the send payment option may initiate a process to create a purchase ID that can be transmitted via the TTP process to the merchant device. Thus, a user may engage in TTP payments for consumer or customer generated transactions in application 112, which may require synchronization of different data processors using the IDs correlated between the processors' data processing flows.

Referring now to FIG. 3B, UIs 300b show a series of different UIs that include an animation and/or flow between user interfaces that may be displayed as a user engages in a TTP payment using in-application transaction data input and/or generated on mobile device 110. In a payment interface 312, an amount 314 may be input by a user, which may be directly input or may be determined when the user selects one or more items for payment. As such, amount 314 may be specified by a user or may be automatically determined from item selections. A mount 314 may be associated with item and sales data, which may be processed for amount 314 when payment is made so that the corresponding merchant is aware of what has been paid for by the user. A payment request options 316 shows various options for payment, including a TTP request 318, that when selected, causes amount 314, as well as any other purchase and/or sales data entered and/or generated in application 112 via payment interface 312, to be transmitted to transaction processor 130 for purchase ID creation.

As such, on selection of TTP request 318 from payment request options 316, the purchase and sales data including amount 314 are sent to transaction processor 130 and application 112 on mobile device 110, which may then transition, navigate, or advance to a pending TTP data interface 322 where the user is informed visually that a payment is being prepared by a pending notification 324, such as when the purchase ID is being created from purchase record generation. Once the purchase ID has been created by transaction processor 130 based on generating a purchase record for amount 314 and any other purchase and sales data, the purchase ID may be provided back to application 112, which may then transition and/or advance from pending TTP data interface 322 to a TTP interface 332. In TTP interface 332, the user using mobile device 110 is informed via a TTP notification 334 that a payment for an amount is now transmissible to the merchant's device via short-range wireless communications through a “tap” or other motion, activity, or action with the mobile device (e.g., by “hold[ing] here to pay” or the like). In this regard, TTP notification 334 may be displayed while broadcasting the purchase ID, when generating a message for the purchase ID and TTP process and/or adding a consumer ID or other payment instrument ID to the message, or otherwise interacting with merchant device 120 and/or transaction processor 130 to provide the purchase ID for the purchase record to merchant device 120 for payment processing. Once the purchase ID is transmitted. via the TTP process, to merchant device 120, merchant device 120 may utilize a separate processor to process a payment, where data synchronization may be provided through the purchase ID and a payment ID for a payment record or information for processing a payment for amount 314 to the merchant associated with merchant device 120 or the merchant's accounts.

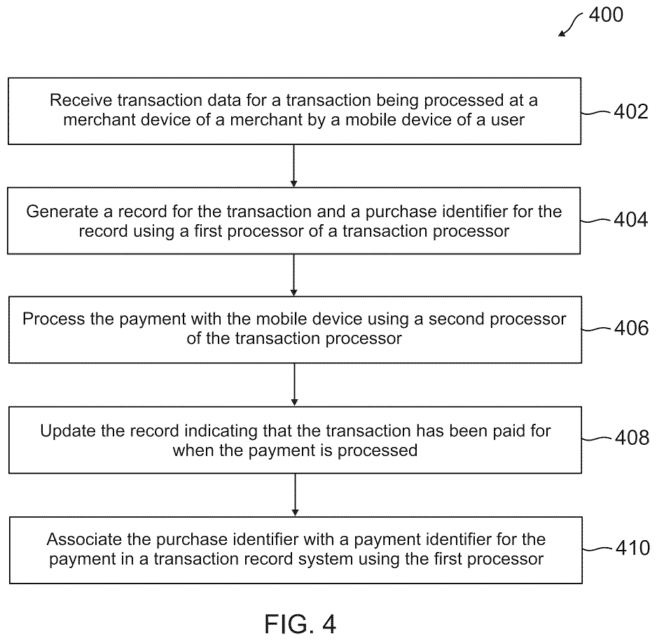

FIG. 4 is a flowchart 400 of an exemplary process enabling unified requests for data processing between multiple data processing queues, according to an embodiment. Note that one or more steps, processes, and methods described herein of flowchart 400 may be omitted, performed in a different sequence, or combined as desired or appropriate. For example, flowchart 400 may generally provide the steps shown in diagram 200a of FIG. 2A when unifying a purchase ID with a payment ID based on a TTP payment being processed. However, one or more of the steps of flowchart 400 may also be performed when providing the synchronizing purchase and payment data, as well as when processing refunds or returns based on a TTP payment from a client-side generated transaction. As such, FIGS. 2A-2C show possible embodiments that may perform one or more of the steps of flowchart 400, although other systems, configurations, and the like may also be used. Further, while flowchart 400 is described with respect to a user generating a transaction on a mobile device and processing the transaction with a merchant device through a TTP process, as discussed herein, the processes may be utilized by other types of data processing where two separate data processors may require synchronization of data and identifiers from different data processing activities.

At step 402 of flowchart 400, transaction data is received for a transaction being processed at a merchant device of a merchant by a mobile device of a user. For example, mobile device 110 in system 100 of FIG. 1 may generate transaction data, such as from a user input, data scans, and/or communications. In application 112 on mobile device 110, a user may select an option to process the transaction with merchant device 120 using a TTP process, such as through short-range wireless communications, which may require the use of transaction processor 130 for payment processing. For example, application 112 may call an API of UPR purchase processor 202, which may allow mobile device 110 to request data processing include transaction and payment processing. This may invoke UPR purchase processor 202 to create a purchase order, but may also require a separate payment processor and/or data processing stack to process a payment using a payment instrument, digital account, or the like of the user.

With refunds, instead of requesting creation of a purchase record usable for purchase processing, application 112 may call UPR purchase processor 202 to determine refund availability. Either way, UPR purchase processor 202 may then respond to mobile device 110 in application 112, as described in the further steps below. In some embodiments, mobile device 110 may provide items and/or sales data, such as item information (identifiers, costs, descriptions, etc.) and shipping, tax, tip, or other cost information, to transaction processor for processing and handling. In this regard, when a user enters or visits a physical merchant location, such as a merchant storefront or retail location, the user may initiate and process a transaction with a corresponding merchant device including POS devices, merchant payment terminals, self or automated checkout registers, and other merchant checkout and payment devices. To utilize a TTP process with consumer- or customer-side transaction data generation in application 112, transaction processor 130 may provide compatibility processes between different processors to enable the processors to perform coordinated data processing, which may include synchronizing and/or correlating data for storage based on IDs used to track payments and purchase records.

At step 404, a record for the transaction and a purchase identifier for the record are generated using a first processor of a transaction processor. In this regard, UPR infrastructure 140 of transaction processor 130 in system 100 may initially perform processing of the transaction data received from mobile device 110 when mobile device 110 indicates a desire to process that transaction data through a TTP process and short-range wireless communications with merchant device 120. The first processor may correspond to UPR purchase processor 202 and UPR purchase processor 202 may create the purchase record with an initial state, such as “Initial” or “Unpaid”, indicating that the payment for the purchase has yet to be processed by another, second processor. The second processor may correspond to TAP API 220, which may process payment between users and/or entities by exchanging, debiting, crediting, and/or otherwise moving funds between accounts of those users and/or entities. In contrast, UPR purchase processor 202 may not directly handle payments between parties, but may coordinate the purchase of items and invoke the second, payment, processor during purchase processing.

Based on the transaction request and the indication that the TTP process and components are to be used as a payment mechanism for in-person payment processing between mobile device 110 and merchant device 120, UPR purchase processor 141 of UPR infrastructure 140 may generate one of purchase records 142 for the transaction, which may store the item data, tax or other cost data, and the like in a data structure, such as an invoice, having an initial state indicating that payment has not been processed and/or is pending. One of purchase IDs 143 may also be generated, which may uniquely identify the purchase record or other data record and/or structure, which allows for processing of a payment for the item data for the corresponding cost. The purchase ID may be sent back to mobile device 110, which may allow mobile device 110 to process a payment with merchant device 120 for the transaction using the TTP process and short-range wireless communications.

At step 406, the payment is processed with the mobile device using a second processor of the transaction processor. In this regard, merchant device 120 may receive the purchase ID via the TTP process where mobile device 110 may be brought into close proximity for short-range wireless communications and transmissions, such as via NFC or RFID although other wireless communication mechanisms may also be used. Mobile device 110 may exchange data via short-range wireless communications using a short-range communication protocol and/or technique. In this regard, mobile device 110 may transmit purchase ID to mobile device via this TTP process, communications, and protocol, which may include transmission of a consumer ID or customer ID that identifies an account or other payment instrument of the user and authorizes a payment to be made using that payment instrument. For example, mobile device 110 may be placed in close proximity to payment reader 212, which may read the TTP request and data from mobile device 110, and payment reader 212 may create a payment for the purchase order and record.

When received by merchant device 110, merchant device 110 may then use the purchase ID as the transaction data for transaction processing, and the consumer/customer ID as the payment instrument, and request transaction processing from transaction processor 130 using transaction processing platform 131. For example, payment reader 212 may generate the payment to request that the consumer ID, or a financial instrument tied to that consumer ID, be debited or charged the amount of the payment. To do this, payment reader 212 may publish payout 214, which may correspond to a message to payout message queue 216 for consumption and processing by exporter service 218. Exporter service 218 may then interact with TAP API 220 for payment processing. Transaction processing platform 131 may process a payment after the purchase ID is received and processed by UPR purchase processor 141 from merchant device 120. Payments system 134 may perform payment processing based on a payout message provided by UPR purchase processor 141 in payout queue 133

At step 408, the record is updated to indicate that the transaction has been paid for when the payment is processed. In this regard, during step UPR purchase processor 141 may transmit a message to payout queue 133 for a payout to be made and payment processing to be performed. Payments system 134 may ingest the message and process a payment, where a payment ID is generated and provided back to mobile device 110, merchant device 120, and/or UPR purchase processor 141 for processing. For example, UPR purchase processor 202 may receive and store the payment ID once generated for a processed payment and received from payout message queue 216. When the payment ID is received, UPR purchase processor 202 may further access the data record from UPR purchase database 204, and may update the record with the payment ID and a status change to “PAID” or similar indicating that the payment for the purchase has been processed and completed. Thus, when the payment ID is received at UPR purchase processor 141, a corresponding one of purchase records 142 may be updated so that states 144 for that record reflects that the transaction has been paid for and completed (e.g., a “paid” status, which may be updated from an “initial” or “pending” status). When updating the record, mobile device 110 may also be updated so that application 112 may provide a corresponding record and indication of payment completion to the customer of the merchant.

At step 410, the purchase identifier is associated with a payment identifier for the payment in a transaction record system using the first processor. In order to provide proper recordation of the data processing provided between the different processors and components involved in the aforementioned data processing flow and operations, UPR infrastructure 140 may generate and transmit a message to purchase queue 145 that may further be ingested and processed by payments system 134 and/or tap payments and refunds module 135 to correlate the payment ID and stored payment data with the purchase ID and purchase record. For example, UPR purchase processor 101 may send sales data to an SQS messaging service or other messaging queueing service whereby the messages may be published to purchase message queue 206 for consumption. Exporter service 218 may consume when updating the export model with the purchase information, and send this export model to TAP API 220 for recordation. Since the purchase record includes a recordation of the payment ID, and the payment ID results from processing a transaction based on the purchase ID and record, when the message referencing the purchase ID and/or payment ID with the item and/or sales data, such as the purchase record and/or data used to generate the purchase record, is received and processed at payments system 134 and/or tap payments and refunds module 135, such item and sales data may be stored or along with the payment data. This creates a full record of the transaction and transaction processing, which may then be used for transaction history generation, auditing, returns and/or refunds, and the like. Additionally, these components may also be invoked and utilized for TTP refunds and/or returns, and other payment processing flows and options, as discussed herein.

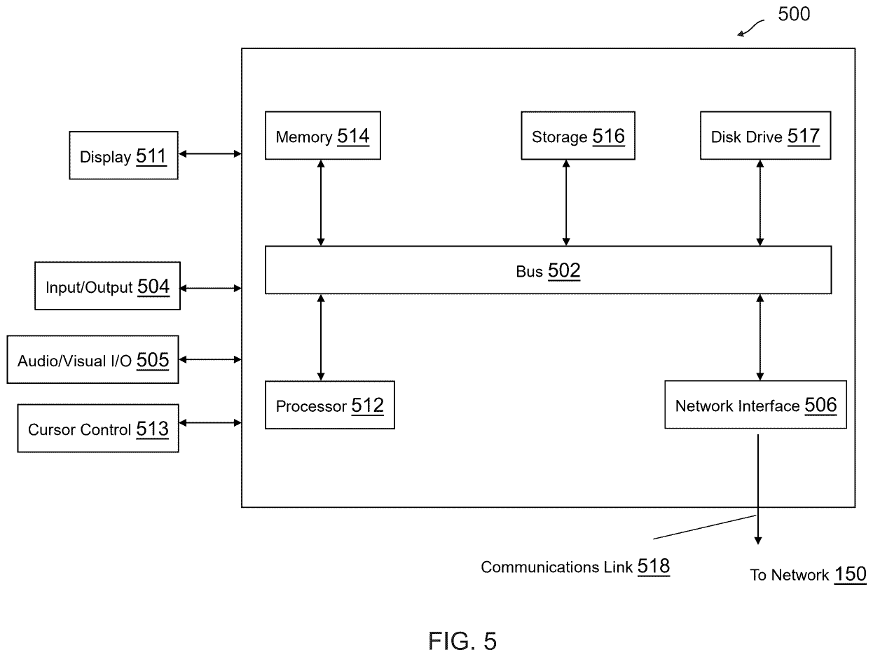

FIG. 5 is a block diagram of a computer system 500 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network.

It should be appreciated that each of the devices utilized by users and service providers may be implemented as computer system 500 in a manner as follows. For example, merchant device 120, transaction processor 130, mobile device 110 and/or one or more of the servers, devices, or other components for transaction processor 130 in FIG. 1 may be implemented by computer system 500. As such, merchant device 120, transaction processor 130, and/or mobile device 110 may each be implemented as and/or utilize the same or similar components to computer system 500.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 150. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM) , a static storage component 516 (e.g., ROM) , and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A system comprising:
a non-transitory memory; and
one or more hardware processors coupled to the non-transitory memory and configured to read instructions from the non-transitory memory to cause the system to perform operations:
receiving, from a mobile device of a user, a request for processing a transaction with a merchant device using a payment terminal connectable with the mobile device via short-range wireless communications;
generating a record for the request for processing the transaction with a first state indicating that a payment for the request has been initiated, wherein the record is generated with a first identifier (ID) enabling a unique identification of at least one of the transaction or the record;
transmitting the first ID to the mobile device that enables the mobile device to process the request with the payment terminal;
processing the payment for the request with a transaction processor associated with the system and an account of the user;
determining that the payment has been processed by the transaction processor for the transaction;
updating the record with a second state indicating that the payment has been made for the transaction; and
associating the first ID for the transaction with payment information for the payment in a transaction record system based at least on the record.

2. The system of claim 1, wherein the first ID is via an application of the mobile device via the short-range wireless communications.

3. The system of claim 2, wherein the short-range wireless communications with the payment terminal is enabled on the mobile device by the mobile application through a software development kit (SDK) associated with the transaction processor.

4. The system of claim 1, wherein the first ID designates the record as a purchase record for an in-store purchase of the payment between the merchant and the user, and wherein the payment information comprises a second ID that identifies the payment record.

5. The system of claim 4, wherein the associating the first ID for the transaction with the payment information comprises:
providing the second ID to a first queue for a purchase service;
creating a message associated with the purchase service; and
providing the message to a second queue associated with a data exporter.

6. The system of claim 5, wherein the message enables the second queue to store the first ID with the second ID in a transaction record with the transaction record system.

7. The system of claim 1, wherein the operations further comprise:
receiving the first ID from a mobile application on the mobile device for a refund of the transaction;
retrieving the payment information using the first ID; and
processing the refund for the transaction based on the payment information.

8. The system of claim 7, wherein the processing the refund comprises:
creating a new record referencing the record for the transaction; and
communicating with a refund service associated with the payment with the new record, wherein the new record enables the refund service to process the refund for the payment, and wherein the calling the refund service enables a refund event messaging service to update the transaction record system.

9. The system of claim 8, wherein the operations further comprise:
creating a message associated with the new record and that references the refund; and
initiating a refund process with the refund service.

10-20. (canceled)

21. A method comprising:
receiving, from a mobile device of a user, a request for processing a transaction with a merchant device using a payment terminal connectable with the mobile device via short-range wireless communications;
generating a record for the request for processing the transaction with a first state indicating that a payment for the request has been initiated, wherein the record is generated with a first identifier (ID) enabling a unique identification of at least one of the transaction or the record;
transmitting the first ID to the mobile device that enables the mobile device to process the request with the payment terminal;
processing the payment for the request with a transaction processor and an account of the user;
determining that the payment has been processed by the transaction processor for the transaction;
updating the record with a second state indicating that the payment has been made for the transaction; and
associating the first ID for the transaction with payment information for the payment in a transaction record system based at least on the record.

22. The method of claim 21, wherein the first ID is via an application of the mobile device via the short-range wireless communications.

23. The method of claim 22, wherein the short-range wireless communications with the payment terminal is enabled on the mobile device by the mobile application through a software development kit (SDK) associated with the online transaction processor.

24. The method of claim 21, wherein the first ID designates the record as a purchase record for an in-store purchase of the payment between the merchant and the user, and wherein the payment information comprises a second ID that identifies the payment record.

25. The method of claim 24, wherein the associating the first ID for the transaction with the payment information comprises:
providing the second ID to a first queue for a purchase service;
creating a message associated with the purchase service; and
providing the message to a second queue associated with a data exporter.

26. The method of claim 25, wherein the message enables the second queue to store the first ID with the second ID in a transaction record with the transaction record system.

27. The method of claim 21, further comprising:
receiving the first ID from a mobile application on the mobile device for a refund of the transaction;
retrieving the payment information using the first ID; and
processing the refund for the transaction based on the payment information.

28. The method of claim 27, wherein the processing the refund comprises:
creating a new record referencing the record for the transaction; and
communicating with a refund service associated with the payment with the new record, wherein the new record enables the refund service to process the refund for the payment, and wherein the calling the refund service enables a refund event messaging service to update the transaction record system.

29. The method of claim 28, further comprising:
creating a message associated with the new record and that references the refund; and
initiating a refund process with the refund service.

30. A non-transitory machine-readable medium having stored thereon machine-readable instructions executable to cause a machine to perform operations comprising:
receiving, from a mobile device of a user, a request for processing a transaction with a merchant device using a payment terminal connectable with the mobile device via short-range wireless communications;
generating a record for the request for processing the transaction with a first state indicating that a payment for the request has been initiated, wherein the record is generated with a first identifier (ID) enabling a unique identification of at least one of the transaction or the record;
transmitting the first ID to the mobile device that enables the mobile device to process the request with the payment terminal;
processing the payment for the request with a transaction processor and an account of the user;
determining that the payment has been processed by the transaction processor for the transaction;
updating the record with a second state indicating that the payment has been made for the transaction; and
associating the first ID for the transaction with payment information for the payment in a transaction record system based at least on the record.

31. The non-transitory machine-readable medium of claim 30, wherein the first ID is via an application of the mobile device via the short-range wireless communications.
